(19) United States
(12) Patent Application Publication
(10) Pub. No.: US 2008/0232116 A1
(43) Pub. Date: Sep. 25, 2008

(54) Lighting device for a recessed light fixture

(75) Inventor: Steven Kim, Palisades Park, NJ (US)

Correspondence Address: SEYFARTH SHAW, LLP, 815 CONNECTICUT AVENUE, N.W., SUITE 500, WASHINGTON, DC, 20006, US

(73) Assignee: LED Folio Corporation, Palisades Park, NJ (US)

(21) Appl. No.: 12/076,744

(22) Filed: Mar. 21, 2008

Related U.S. Application Data
(60) Provisional application No. 60/907,155, filed on Mar. 22, 2007.

(51) Int. Cl. F21V 15/00

(52) U.S. Cl. 362/365

(57) ABSTRACT

A lighting device for an opening of a recessed light fixture includes a plate for mounting at the opening of the recessed light fixture, the plate having a first side for facing the recessed light fixture and a second side opposite to the first side, a light emitting diode lighting panel attached at the second side of the plate, and a power supply unit for insertion into a socket of the recessed light fixture, wherein the power supply unit is for providing power to the light emitting diode panel.

This invention claims the benefit of the Provisional Patent Application No. 60/907,155 filed with the U.S. Patent and Trademark Office on Mar. 22, 2007, which is hereby incorporated by reference in its entirety.

### BACKGROUND OF THE INVENTION

The embodiments of the invention relate to a lighting device. Although embodiments of the invention are suitable for a wide scope of applications, they are particularly suitable to a lighting device for a recessed light fixture.

Various light fixtures are used to illuminate interior spaces. These include candelabras, chandeliers, track lighting and recessed light fixtures. The latter are used when the lighting bulbs are to be hidden from view or otherwise unobtrusive. Most commonly, incandescent lighting is used in recessed light fixtures.

FIG. 1A shows a prior art recessed can light fixture. FIG. 1B shows a bottom view of the recessed can light fixture of FIG. 1A. As shown in FIG. 1A, the recessed can light fixture 100 includes a can 101 for holding a light bulb 150. The can is affixed to the ceiling 1 using the affixing tabs 102a and 102b. The light fixture 10 includes a socket 103 into which an end of the light bulb 150 is inserted to provide electrical power to the light bulb 150.

The recessed can light fixture 100 also includes springs 104a and 104b for retaining a beauty ring 105 that covers the bottom edge 101a of the can 101, as shown in FIG. 1A. The beauty ring 105 is shown in profile in FIG. 1A and from the bottom in FIG. 2A. The purpose of the beauty ring 105 is to completely cover the edge 101a of the can 101, so only the light bulb 150 and the beauty ring 105 are visible when the can 101 is viewed from below, as shown in FIG. 1B. Further, the beauty ring 105 covers the bottom edge 101a of the can 101.

A recent trend in interior lighting is to replace incandescent bulbs with fluorescent bulbs. Fluorescent bulbs are advantageous over incandescent bulbs primarily because of their greater longevity and higher efficiency. In many cases, fluorescent bulbs can increase operating efficiencies several-fold without substantially sacrificing brightness, lighting quality or color. Fluorescent bulbs are used in recessed light fixtures as well with the same advantages.

Interior lighting based on the use of light emitting diode technology is still relatively new. However, light emitting diode technology provides lighting capabilities at far greater efficiency than can be provided by fluorescent bulbs. Recent improvements have raised the brightness and lighting quality of light emitting diode light fixtures up to the standards of incandescent bulbs. However, light emitting diodes in the light emitting diode lighting panels used in light fixtures of various types are susceptible to overheating. When overheating occurs, the efficiency and lifetime of the light emitting diodes decreases. In some cases, overheating may lead to catastrophic failure in the light emitting diodes and/or create safety hazards.

### SUMMARY OF THE INVENTION

Accordingly, embodiments of the invention are directed to a lighting device that substantially obviates one or more of the problems due to limitations and disadvantages of the related art.

An object of embodiments of the invention is to provide a lighting device with a light emitting diode panel that can be affixed to a recessed fixture.

Another object of embodiments of the invention is to provide a lighting device for a recessed fixture in which the light emitting diode panel is removably connected to a power supply.

Another object of embodiments of the invention is to provide a lighting device in which a light emitting diode panel is affixed to a plate near the opening of the recessed fixture.

Additional features and advantages of embodiments of the invention will be set forth in the description which follows, and in part will be apparent from the description, or is learned by practice of embodiments of the invention. The objectives and other advantages of the embodiments of the invention will be realized and attained by the structure particularly pointed out in the written description and claims hereof as well as the appended drawings.

To achieve these and other advantages and in accordance with the purpose of embodiments of the invention, as embodied and broadly described, a lighting device for an opening of a recessed light fixture includes a plate for mounting at the opening of the recessed light fixture, the plate having a first side for facing the recessed light fixture and a second side opposite to the first side, a light emitting diode lighting panel attached at the second side of the plate, and a power supply unit for insertion into a socket of the recessed light fixture, wherein the power supply unit is for providing power to the light emitting diode panel.

In another aspect, a lighting device for an opening of a recessed light fixture includes a plate for mounting at the opening of the recessed light fixture, the plate having a first side for facing the recessed light fixture and a second side opposite to the first side, a light emitting diode lighting panel attached at the second side of the plate, the light emitting diode lighting panel having a first connector, and a power supply unit for insertion into a socket of the recessed light fixture, wherein the power supply unit has a second connector for connecting to the first connector.

In another aspect, a lighting device for an opening of a recessed light fixture includes a plate for mounting at the opening of the recessed light fixture, the plate having a first side for facing the recessed light fixture and a second side opposite to the first side, a light emitting diode lighting panel attached at the second side of the plate, the light emitting diode lighting panel including a flexible strip of light emitting diodes, attachment mechanisms for affixing the light emitting diode lighting panel at the second side of the plate, and a power supply unit for insertion into a socket of the recessed light fixture, wherein the power supply unit has a second connector for connecting to the first connector.

It is to be understood that both the foregoing general description and the following detailed description are exemplary and explanatory and are intended to provide further explanation of embodiments of the invention as claimed.

### BRIEF DESCRIPTION OF THE DRAWINGS

The accompanying drawings, which are included to provide a further understanding, of embodiments of the invention and are incorporated in and constitute a part of this specification, illustrate embodiments of the invention and together with the description serve to explain the principles of embodiments of the invention.

FIG. 1A shows a prior art recessed can light fixture;

FIG. 1B shows a bottom view of the recessed can light fixture of FIG. 1A;

FIG. 2A shows a recessed can light fixture with a light emitting diode panel retained by fixed posts;

FIG. 2B shows a top view of the light emitting diode panel of FIG. 2A;

FIG. 3A shows a recessed can light fixture with a light emitting diode panel retained by pinch-pins;

FIG. 3B shows a top a view of the light emitting diode panel of FIG. 3A;

FIG. 4A shows a recessed can light fixture with a light emitting diode panel retained by spade connectors;

FIG. 4B shows a top a view of the light emitting diode panel of FIG. 4A;

FIG. 5A shows a recessed can light fixture with a light emitting diode panel retained by bolts;

FIG. 5B shows a top a view of the light emitting diode panel of FIG. 5A;

FIG. 6A shows a recessed can light fixture with a light emitting diode panel having ventilation holes and retained by bolts;

FIG. 6B shows a top a view of the light emitting diode panel of FIG. 6A;

FIG. 7A shows a recessed can light fixture with a light emitting diode panel having ventilation holes and retained by bolts; and

FIG. 7B shows a top a view of the light emitting diode panel of FIG. 7A.

### DETAILED DESCRIPTION OF THE PREFERRED EMBODIMENTS

Reference will now be made in detail to the preferred embodiments of the invention, examples of which are illustrated in the accompanying drawings. It will be apparent to those skilled in the art that various modifications and variations is made in the embodiments of the invention, the lighting device, without departing from its spirit or scope. Thus, it is intended that embodiments of the invention cover the modifications and variations of this invention provided they come within the scope of the appended claims and their equivalents. In the drawings, the thicknesses of layers and regions are exaggerated for clarity. Like reference numerals in the drawings denote like elements.

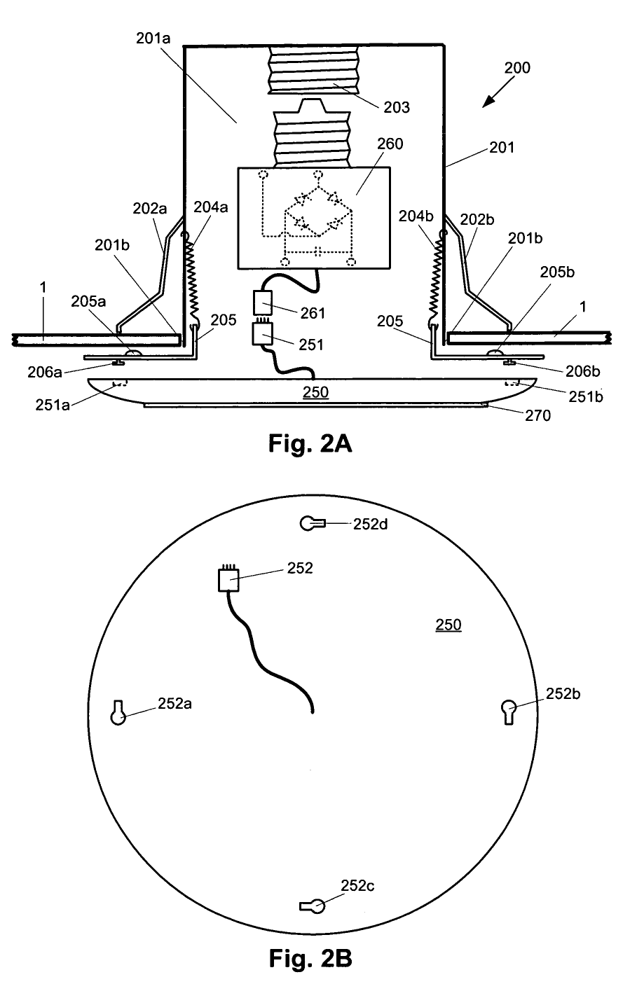

FIG. 2A shows a recessed can light fixture with a light emitting diode panel retained by fixed posts. FIG. 2B shows a top view of the light emitting diode panel of FIG. 2A. As shown in FIG. 2A, the recessed can light fixture 200 includes a can 201 for containing electrical connections and a light emitting diode panel 250.

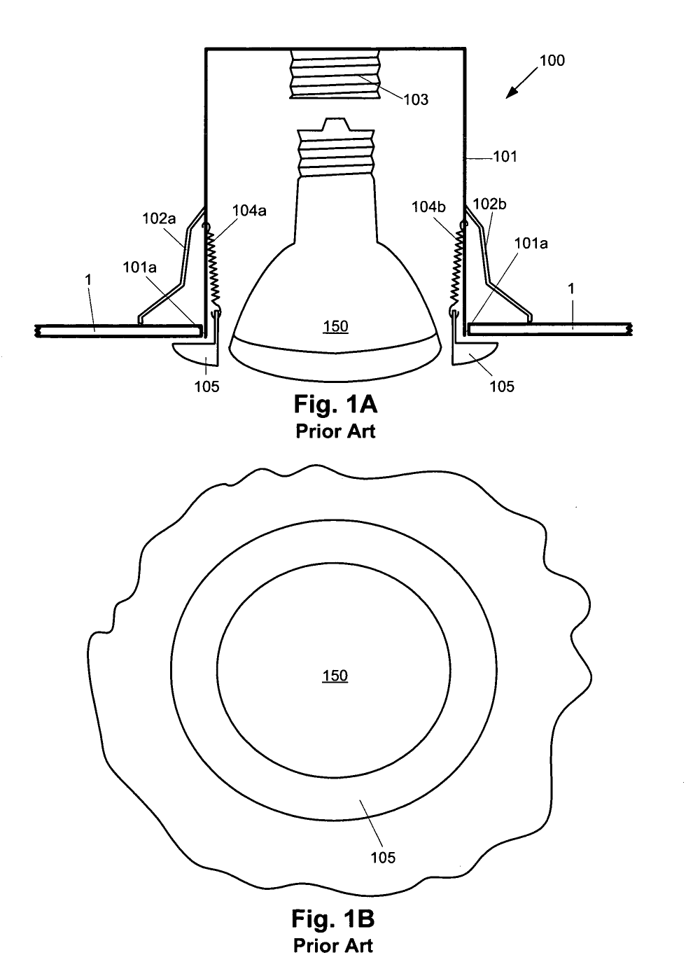

The can 201 is affixed to the ceiling 1 using the affixing tabs 202a and 202b. The affixing tabs 202a and 202b are either an integral part of the can 201, or separate parts that fit into the can walls via a tab and slot mechanism (not shown). The can 201 is cylindrically shaped, as shown in FIG. 1A. Alternatively, the can 201 has one of a number of different shapes, including that of a rectangular prism or a prism, with a triangular cross section. Alternatively, the can 201 has a spherical, semi-spherical, a shape with a circular cross section or other elliptical shape. The can 201 is made from metal, plastic or a combination thereof. The can 201 has a seamless wall. Alternatively, the can 201 has a seam, a hole or ancillary cavities (not shown) in the wall of the can 201.

The socket 203 supplies power to the light emitting diode panel 250 through a power supply 260. The socket 203 can alternatively receive an incandescent light bulb (not shown) or a fluorescent light bulb (not shown). The power supply 260 is electrically connected to the socket 203, as shown in FIG. 2A. The light emitting diode panel 250 is then connected to the power supply 260 by connecting the connector 251 of the light emitting diode panel 250 to the connector 261 of the power supply 260. The power supply 260 contains an AC/DC converter, a transformer and other power conversion devices (not shown). The connector 251 of the light emitting diode panel 250 and the connector 261 of the power supply 260 are reversibly connected, as shown in FIG. 2A. Alternatively, the connector 251 of the light emitting diode panel 250 and the connector 261 of the power supply 260 are permanently connected.

The connector 251 of the light emitting diode panel 250 and the connector 261 of the power supply 260 are reversibly connected using a plug and socket type connection, as shown in FIG. 2A, or pins and sockets, tabs and slits and other types of reversible connectors (not shown). The connector 251 of the light emitting diode panel 250 is connected to the light emitting diode panel 250 via a flexible wire as shown in FIGS. 2A and 2B, or the connector 251 of the light emitting diode panel 250 is connected to the light emitting diode panel 250 via another type of interconnection, such as an inflexible wire, flexible or inflexible ribbon, flexible or inflexible post (not shown). The connector 261 of the power supply 260 is connected to the power supply 260 via a flexible wire as shown in FIGS. 2A and 2B, or in the alternative, connector 261 of the power supply 260 is connected to the power supply 260 via another type of interconnection, such as an inflexible wire, flexible or inflexible ribbon, flexible or inflexible post (not shown).

Because the connector 251 of the light emitting diode panel 250 and the connector 261 of the power supply 260 are reversibly connected, either component is independently replaceable. In particular, disconnecting the connectors 251 and 261 allows one of the light emitting diode panel 250 and the power supply 260 to be replaced without having to replace the other component. This is useful since the lifetimes of the light emitting diode panel 250 and the power supply 260 differ so as to result in the need to replace one of these components more often than the other. For example, the electronics associated with the power supply 260 could be more prone to overheating and subject to short circuiting and burn-out. Reversibility of the connectors 251 and 261 allows the replacement of either the light emitting diode panel 250 or the power supply 260 as needed. Additionally, the reversibility of connectors 251 and 261 allows quick removal and repair of either the power supply 260 or the light emitting diode panel 250.

When the light emitting diode panel 250 and power supply 260 are not installed in the can 201, a light bulb (not shown) could be inserted into the socket 203 so as to provide electrical power to the light bulb (not shown). The socket 203 is either a single bulb socket, as shown in FIG. 2A, or is a multiple socket for multiple bulbs (not shown). In another alternative, the socket 203 has other features such as an outlet (not shown) for supplying power to electronic devices (not shown) or additional connections including wires (not shown), additional sockets (not shown) or pin connects (not shown).

The recessed can light fixture 200 also includes springs 204a and 204b for retaining a plate 205 near the bottom edge 201b of the can 201, as shown in FIG. 2A. Alternatively, the plate 205 is affixed to the can 201 by fasteners (not shown) or a fastening mechanism (not shown) other than a spring. The springs 204a and 204b are fastened directly to the can, as shown in FIG. 2A. Alternatively, the springs 204a and 204b are fastened indirectly to the walls of the can 201 through an intermediate part attached to the can 201 or through another portion of the recessed can light fixture 200.

The springs 204a and 204b allow the plate 205 to be temporarily displaced from the can 201 in a direction away from the socket 203, when the plate is pulled in that direction by the user. Once the user ceases to pull on the plate 205, the springs 204a and 204b cause the plate 205 to return to the original configuration shown in FIG. 2A. The displacement of the plate 205 from the can 201 allowed by the springs 204a and 204b enable the removal and replacement of the light emitting diode panel 250 and the replacement of the power supply 260.

Typically, the plate 205 covers the bottom edge 201b of the can 201, as shown in FIG. 2A. Alternatively, portions of the plate 205 retaining the light emitting diode panel 250 cover only some portions of the bottom edge 201b of the can 201. The plate 205 could have one of a number of shapes that provide attachment points for the light emitting diode panel 250, including the ring shape shown in profile in FIG. 2A.

The plate 205 has posts 206a and 206b, as shown in FIG. 2A, for affixing the light emitting diode panel 250. Although only two posts 206a and 206b are shown in profile in FIG. 2A, there are four posts in total on the plate 205 and posts 206c and 206d are not shown. In the alternative, there could be two, three, five or more posts on the plate 205. The number of posts in the plate 205 is at least equal to the number of post-accepting eyelets in the light emitting diode panel 250.

Each of the posts 206a and 206b is positioned around the circumference of the plate 205 to correspond to one of the post-accepting eyelets, 252a-252d, respectively, on the light emitting diode panel 250. Each of the posts 206a and 206b are placed into the post-accepting eyelets 252a and 252b of the light emitting diode panel 250 and either snap fastens to a post-accepting eyelet 252a-252d or is fixed in place by rotating the light emitting diode panel 250 until each of the posts 206a and 206b is fixed in a post-accepting eyelet 252a and 252b. The fixed posts 206a and 206b lock the light emitting diode panel 250 to the plate 205 until the fixed posts 206a and 206b are deliberately dislodged from the post-accepting eyelets 252a-252d by the user either by pulling or rotating the light emitting diode panel 250.

The plate 205 has bumps 205a and 205b holding the plate 205 away from the ceiling 1 to provide ventilation to the interior 201a of the can 201 where the power supply 260 and the light emitting diode panel 250 are located. Two bumps, as shown in FIG. 2A, or more than two bumps can be provide on the plate 205 to further stabilize the plate 205 with respect to the ceiling 1. Air passages between the ceiling 1 and the plate 205 are created by the bumps 205a and 205b for ventilation. Such air passages cool both the power supply 260 and light emitting diode panel 250 both of which can heat-up, during normal operation, to temperatures that could degrade the operating efficiency or the lifetime of the power supply 260 and light emitting diode panel 250. Cooling due to ventilation created by the bumps 205a and 205b prolongs the lifetime of the power supply 260, light emitting diode panel 250 and other electronics or connections (not shown) in the can 201.

As shown in FIG. 2A, the light emitting diode panel 250 can also have a lens 270 for dispersing the light produced by the light emitting diodes (not shown) of the light emitting diode panel 250. The lens 270 distributes the light emitted by the light emitting diode panel 250 to light interior spaces more efficiently. In the alternative, the lens 270 also includes reflective surfaces to increase the refraction of redirected light, or to redirect light to specific targets. In another alternative, the lens 270 has more than one lens for both focusing and dispersion of the light created by the light emitting diode panel 250. In yet another alternative, the lens 270 further includes one or several optical elements (not shown), such as light guide panels, convex or concave lenses, filters, parabolic, flat mirrors, shaped-mirrors, polarizers or light blocking devices (not shown).

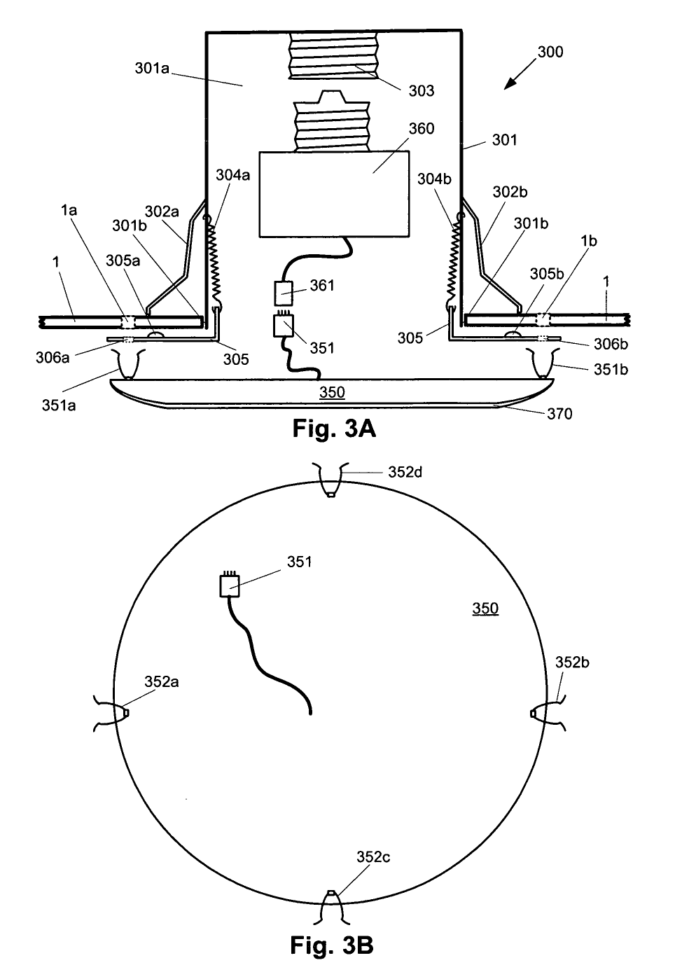

FIG. 3A shows a recessed can light fixture with a light emitting diode panel retained by pinch-pins. FIG. 3B shows a top a view of the light emitting diode panel with pinch-pins of FIG. 3A. As shown in FIG. 3A, the recessed can light fixture 300 includes a can 301 for containing electrical connections and a light emitting diode panel 350.

The can 301 is affixed to the ceiling 1 using the affixing tabs 302a and 302b. The affixing tabs 302a and 302b are either an integral part of the can 301, or fit into the can walls via a tab and slot mechanism (not shown). The can 301 is cylindrically shaped, as shown in FIG. 3A. Alternatively, the can 301 has one of a number of different shapes including that of a rectangular prism or a prism with a triangular cross section. Alternatively, the can 301 has a spherical, semi-spherical, a shape with a circular cross section or other elliptical shape. The can 301 is made from metal, plastic or a combination thereof. The can 301 has a seamless wall. Alternatively, the can 301 has a seam, holes or ancillary cavities (not shown) in the walls of the can 301.

The socket 303 supplies power to the light emitting diode panel 350 through a power supply 360. The socket 303 can alternatively receive an incandescent light bulb (not shown) or a fluorescent light bulb (not shown). The power supply 360 is electrically connected to the socket 303, as shown in FIG. 3A. The light emitting diode panel 350 is then connected to the power supply 360 by connecting the connector 351 of the light emitting diode panel 350 to the connector 361 of the power supply 360. The power supply 360 contains an AC/DC converter, a transformer and other power conversion devices (not shown). The connector 351 of the light emitting diode panel 350 and the connector 361 of the power supply 360 are reversibly connected, as shown in FIG. 3A. Alternatively, the connector 351 of the light emitting diode panel 350 and the connector 361 of the power supply 360 are permanently connected.

The connector 351 of the light emitting diode panel 350 and the connector 361 of the power supply 360 are reversibly connected using a plug and a socket type connection, as shown in FIG. 3A, or pins and sockets, tabs and slits and other types of reversible connectors (not shown). The connector 351 of the light emitting diode panel 350 is connected to the light emitting diode panel 350 via a flexible wire as shown in FIGS. 3A and 3B, or the connector 351 of the light emitting diode panel 350 is connected to the light emitting diode panel 350 via another type of interconnection, such as an inflexible wire, flexible or inflexible ribbon, flexible or inflexible post (not shown). The connector 361 of the power supply 360 is connected to the power supply 360 via a flexible wire as shown in FIGS. 3A and 3B, or in the alternative, connector 361 of the power supply 360 is connected to the power supply 360 via another type of interconnection, such as an inflexible wire, flexible or inflexible ribbon, flexible or inflexible post (not shown).

Because the connector 351 of the light emitting diode panel 350 and the connector 361 of the power supply 360 are reversibly connected, either component is independently replaceable. In particular, disconnecting the connectors 351 and 361 allows one of the light emitting diode panel 350 and the power supply 360 to be removed without having to remove the other component. This is useful since the lifetimes of the light emitting diode panel 350 and the power supply 360 differ so as to result in the need to replace one of these components more often than the other. For example, the electronics associated with the power supply 360 could be more prone to overheating and subject to short circuiting and burn-out. Reversibility of the connectors 351 and 361 allows the replacement of either the light emitting diode panel 350 or the power supply 360 as needed. Additionally, the reversibility of connectors 351 and 361 allows quick removal and repair of either the power supply 360 or the light emitting diode panel 350.

When the light emitting diode panel 350 and power supply 360 are not installed in the can 301, a light bulb (not shown) can be inserted into the socket 303 so as to provide electrical power to the light bulb (not shown). The socket 303 is either a single bulb socket, as shown in FIG. 3A, or is a multiple socket for multiple bulbs (not shown). In another alternative, the socket 303 has other features, such as an outlet (not shown) for supplying power to electronic devices (not shown) or additional connections including wires (not shown), additional sockets (not shown) or pin connects (not shown).

The recessed can light fixture 300 also includes springs 304a and 304b for retaining a plate 305 near the bottom edge 31b of the can 301, as shown in FIG. 3A. Alternatively, the plate 305 is affixed to the can 301 by fasteners (not shown) or a fastening mechanism (not shown) other than a spring. The springs 304a and 304b are fastened directly to the can 301, as shown in FIG. 3A. Alternatively, the springs 304a and 304b are fastened indirectly to the walls of the can through an intermediate part attached to the can 301 or through another portion of the recessed can light fixture 300.

The springs 304a and 304b allow the plate 305 to be temporarily displaced from the can in a direction away from the socket 303, when the plate is pulled in that direction by the user. Once the user ceases to pull on the plate 305, the springs 304a and 304b cause the plate 305 to return to the original configuration shown in FIG. 3A. The displacement of the plate 305 from the can 301 allowed by the he springs 304a and 304b enable the removal and replacement of the light emitting diode panel 350 and the replacement of the power supply 360.

Typically, the plate 305 covers the bottom edge 301b of the can 301, as shown in FIG. 3A. Alternatively, portions of the plate 305 do not cover some portions of the bottom edge 301b of the can 301 that do not retain the light emitting diode panel 350. The plate 305 could have one of a number of shapes, including the ring shape shown in profile in FIG. 3A.

The light emitting diode panel could have pinch-pins 352a-352d, the plate 305 has pinch-pin accepting holes 306a and 306b and the ceiling 1 has pinch-pin accepting holes 1a and 1b, as shown in FIGS. 3A and 3B, for affixing the light emitting diode panel 350. Although the profile view of FIG. 3A only shows two pinch-pin accepting holes 306a and 306b in the plate 305 and two pinch-pin accepting holes 1a and 1b in the ceiling 1, there are four pinch-pin accepting holes in total on the plate 305 and four pinch-pin accepting holes in total in the ceiling 1. In the alternative, there could be two, three, five or more pinch-pin accepting holes and pinch-pins. The number of pinch-pin accepting holes in both the plate 305 and the ceiling 1 is at least equal to the number of pinch-pins. Each of the pinch-pin accepting holes 306a and 306b in the plate 305 and each of the pinch-pin accepting holes 1a and 1b in the ceiling 1 is positioned around the circumference of the plate 305 to correspond to a pinch-pin, 352a and 352b, respectively.

To attach the light emitting diode panel 350, each of the pinch-pins 352a and 352b is collapsed by pinching (not shown) and then inserted into the respective pinch-pin accepting hole 306a and 306b in the plate 305 and the respective pinch-pin accepting hole 1a and 1b in the ceiling 1. Subsequently, each of the pinch-pins 352a and 352b is released. The action of releasing the pinch-pins 352a and 352b inside the pinch-pin accepting holes 306a and 306b, and 1a and 1b, allows the pinch-pins 352a and 352b to expand, push on the walls of the pinch-pin accepting holes 306a and 306b and 1a and 1b and, thereby, create a force between the pinch-pins 352a and 352b and the plate 305 that prevents the light emitting diode panel 350 from separating from the plate 305. In other words, the light emitting diode panel 350 is affixed to the plate 305 by the pinch-pins 352a-352d. The light emitting diode panel 350 is separated from the plate 305 by pinching the pinch-pins 352a-352d and sliding the light emitting diode panel 350 downward until each of the pinch-pins 352a-352d exits the respective pinch-pin accepting holes in the ceiling 1 and then exits the respective pinch-pin accepting hole 306a and 306b in the plate 305.

The plate 305 has bumps 305a and 305b holding the plate 305 away from the ceiling 1 to provide ventilation to the interior 301a of the can 301 so as to dissipate heat from the power supply 360 and the light emitting diode panel 350. There can be two bumps, as shown in FIG. 3A, or more than two bumps to further stabilize the plate 305 with respect to the ceiling 1. Ventilation from air passages created by the bumps 305a and 305b cools both the power supply 360 and light emitting diode panel 350 both of which can heat, during normal operation, to temperatures that could degrade the operating efficiency or the lifetime of the power supply 360 and light emitting diode panel 350. Cooling due to ventilation created by the bumps 305a and 305b prolongs the lifetime of the power supply 360, light emitting diode panel 350 and other electronics or connections (not shown) in the can 301.

As shown in FIG. 3A, the light emitting diode panel 350 also has a lens 370 for dispersing the light produced by the light emitting diodes (not shown) of the light emitting diode panel 350. The lens 370 distributes the light emitted by the light emitting diode panel 350 to light interior spaces more efficiently. In the alternative, the lens 370 also includes reflective surfaces to increase the refraction of redirected light, or to redirect light to specific targets. In another alternative, the lens 370 has more than one lens for both focusing and dispersion of the light created by the light emitting diode panel 350. In yet another alternative, the lens 370 further includes one or several optical elements (not shown), such as light guide panels, convex or concave lenses, filters, parabolic, flat mirrors, shaped-mirrors, polarizers or light blocking devices (not shown).

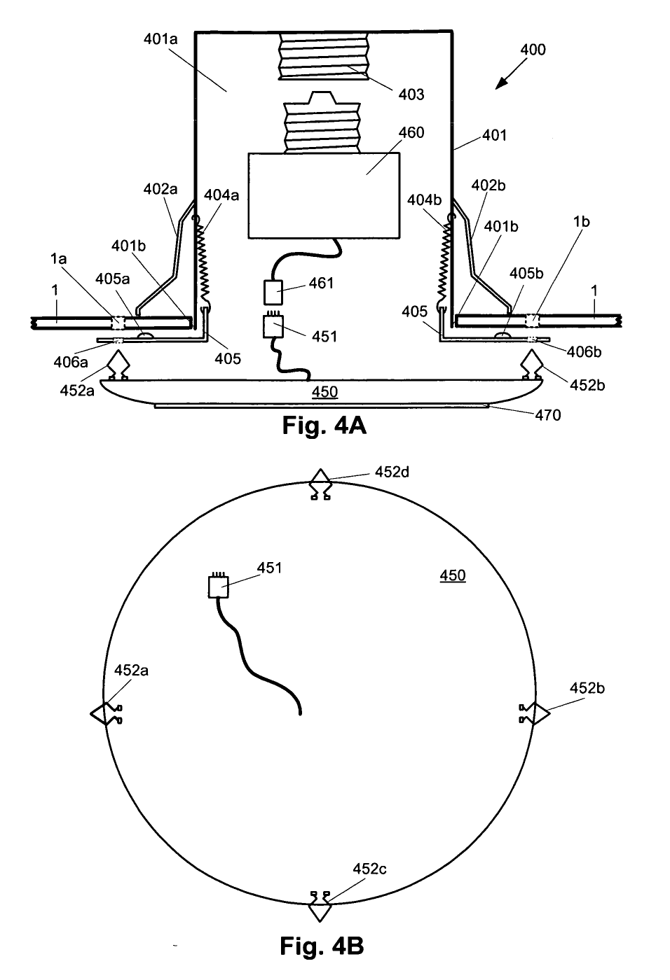

FIG. 4A shows a recessed can light fixture with a light emitting diode panel retained by spade connectors. FIG. 4B shows a top a view of the light emitting diode panel of FIG. 4A. As shown in FIG. 4A, the recessed can light fixture 400 includes a can 401 for containing electrical connections and a light emitting diode panel 450.

The can 401 is affixed to the ceiling 1 using the affixing tabs 402a and 402b. The affixing tabs 402a and 402b are an integral part of the can 401, or fit into the can walls via a tab and slot mechanism (not shown). The can 401 is cylindrically shaped, as shown in FIG. 4A. Alternatively, the can 401 has one of a number of different shapes including that of a rectangular prism or a prism with a triangular cross section. Alternatively, the can 401 has a spherical, semi-spherical, a shape with a circular cross section or other elliptical shape. The can 401 is made from metal, plastic or a combination thereof. The can 401 has a seamless wall. Alternatively, the can 401 has a seam, holes or ancillary cavities (not shown) in the walls of the can 401.

The socket 403 supplies power to the light emitting diode panel 450 through a power supply 460. The socket 403 can alternatively receive an incandescent light bulb (not shown) or a fluorescent light bulb (not shown). The power supply 460 is electrically connected to the socket 403, as shown in FIG. 4A. The light emitting diode panel 450 is then connected to the power supply 460 by connecting the connector 451 of the light emitting diode panel 450 to the connector 461 of the power supply 460. The power supply 460 contains an AC/DC converter, a transformer and other power conversion devices (not shown). The connector 451 of the light emitting diode panel 450 and the connector 461 of the power supply 460 are reversibly connected, as shown in FIG. 4A. Alternatively, the connector 451 of the light emitting diode panel 450 and the connector 461 of the power supply 460 are permanently connected.

The connector 451 of the light emitting diode panel 450 and the connector 461 of the power supply 460 are reversibly connected using a plug and a socket type connection, as shown in FIG. 4A, or pins and sockets, tabs and slits and other types of reversible connectors (not shown). The connector 451 of the light emitting diode panel 450 is connected to the light emitting diode panel 450 via a flexible wire as shown in FIGS. 4A and 4B, or the connector 451 of the light emitting diode panel 450 is connected to the light emitting diode panel 450 via another type of interconnection, such as an inflexible wire, flexible or inflexible ribbon, flexible or inflexible post (not shown). The connector 461 of the power supply 460 is connected to the power supply 460 via a flexible wire as shown in FIGS. 4A and 4B, or in the alternative, connector 461 of the power supply 460 is connected to the power supply 460 via another type of interconnection, such as an inflexible wire, flexible or inflexible ribbon, flexible or inflexible post (not shown).

Because the connector 451 of the light emitting diode panel 450 and the connector 461 of the power supply 460 are reversibly connected, either component is independently replaceable. In particular, disconnecting the connectors 451 and 461 allows one of the light emitting diode panel 450 and the power supply 460 to be removed without having to remove the other component. This is useful since the lifetimes of the light emitting diode panel 450 and the power supply 460 differ so as to result in the need to replace one of these components more often than the other. For example, the electronics associated with the power supply 460 could be more prone to overheating and subject to short circuiting and burn-out. Reversibility of the connectors 451 and 461 allows the replacement of either the light emitting diode panel 450 or the power supply 460 on the appropriate time scale. Additionally, the reversibility of connectors 451 and 461 allows the quick removal and repair of either the power supply 460 or the light emitting diode panel 450.

When the light emitting diode panel 450 and power supply 460 are not installed in the can 401, a light bulb (not shown) could be inserted into the socket 403 so as to provide electrical power to the light bulb (not shown). The socket 403 is either a single bulb socket, as shown in FIG. 4A, or is a multiple socket for multiple bulbs (not shown). In another alternative, the socket 403 has other features such as an outlet (not shown) for supplying power to electronic devices (not shown) or additional connections including wires (not shown), additional sockets (not shown) or pin connects (not shown).

The recessed can light fixture 400 also includes springs 404a and 404b for retaining a plate 405 near the bottom edge 401b of the can 401, as shown in FIG. 4A. Alternatively, the plate 405 is affixed to the can 401 by fasteners (not shown) or a fastening mechanism (not shown) other than a spring. The springs 404a and 404b are fastened directly to the can, as shown in FIG. 4A. Alternatively, the springs 404a and 404b are fastened indirectly to the walls of the can through an intermediate part attached to the can 401 or through another portion of the recessed can light fixture 400.

The springs 404a and 404b allow the plate 405 to be temporarily displaced from the can in a direction away from the socket 403, when the plate is pulled in that direction by the user. Once the user ceases to pull on the plate 405, the springs 404a and 404b cause the plate 405 to return to the original configuration shown in FIG. 4A. The displacement of the plate 405 from the can 401 allowed by the springs 404a and 404b enable the removal and replacement of the light emitting diode panel 450 and the replacement of the power supply 460. Typically, the plate 405 covers the bottom edge 401b of the can 401, as shown in FIG. 4A. Alternatively, portions of the plate 405 do not cover some portions of the bottom edge 401b of the can 401 that do not retain the light emitting diode panel 450. The plate 405 could have one of a number of shapes, including the ring shape shown in profile in FIG. 4A.

The light emitting diode panel 450 has spade connectors 452a-452d, the plate 405 has spade connector accepting holes 406a and 406b and the ceiling has spade connector accepting holes 1a and 1b as shown in FIGS. 4A and 4B, for affixing the light emitting diode panel 450. Although the profile view of FIG. 3A only shows two spade connector accepting holes 406a and 406b in the plate 405 and two spade connector accepting holes 1a and 1b in the ceiling 1, there are four spade connector accepting holes in total on the plate 405 and four spade connector accepting holes in total in the ceiling 1. In the alternative, there could be two, three, five or more spade connector accepting holes and spade connectors. The number of spade connector accepting holes in the plate 405 and number of spade connector accepting holes in the ceiling 1 are at least equal to the number of spade connectors in the light emitting diode panel 450. Each of the four spade connector accepting holes in the plate 405 and each of the four spade connector accepting holes in the ceiling 1 is positioned around the circumference of the plate 405 to correspond to a spade connector, 452a, 452b, 452c and 452d, respectively.

To mount the plate 405, each of the spade connectors 452a and 452b is collapsed by pinching (not shown) and inserted into the respective spade connector accepting hole 406a and 406b in the plate 405 and into the respective spade connector accepting holes in the ceiling 1. Subsequently, each of the spade connectors 452a and 452b is released. The action of releasing the spade connectors 452a and 452b inside spade connector accepting holes 1a and 1b, allows the spade connectors to expand, push on the walls of the spade connector accepting holes and, thereby, create a force between the spade connectors 452a and 452b and the plate 405 that prevents the light emitting diode panel 450 from separating from the plate 405. In other words, the light emitting diode panel 450 is affixed to the plate 405. The light emitting diode panel 450 is separated from the plate 405 by pinching the spade connectors 452a and 452b and sliding the light emitting diode panel 450 downward until each of the spade connectors 452a and 452b first exits the respective spade connector accepting hole in the ceiling 1 and then exits the respective spade connector accepting hole in the plate 405.

The plate 405 has bumps 405a and 405b holding the plate 405 away from the ceiling 1 to provide ventilation to the interior 401a of the can 401 so as to dissipate heat from the power supply 460 and the light emitting diode panel 450. There can be two bumps, as shown in FIG. 4A, or more than two bumps to further stabilize the plate 405 with respect to the ceiling 1. Ventilation from the air passages (not shown) created by the bumps 405a and 405b cools both the power supply 460 and light emitting diode panel 450 both of which can heat, during normal operation, to temperatures that could degrade the operating efficiency or the lifetime of the power supply 460 and light emitting diode panel 450. Cooling due to ventilation created by the bumps 405a and 405b prolongs the lifetime of the power supply 460, light emitting diode panel 450 and other electronics or connections (not shown) in the can 401.

As shown in FIG. 4A, the light emitting diode panel 450 also has a lens 470 for dispersing the light produced by the light emitting diodes (not shown) of the light emitting diode panel 450. The lens 470 distributes the light emitted by the light emitting diode panel 450 to light interior spaces more efficiently. In the alternative, the lens 470 also includes reflective surfaces to increase the refraction of redirected light, or to redirect light to specific targets. In another alternative, the lens 470 has more than one lens for both focusing and dispersion of the light created by the light emitting diode panel 450. In yet another alternative, the lens 470 further includes one or several optical elements (not shown), such as light guide panels, convex or concave lenses, filters, parabolic, flat mirrors, shaped-mirrors, polarizers or light blocking devices (not shown).

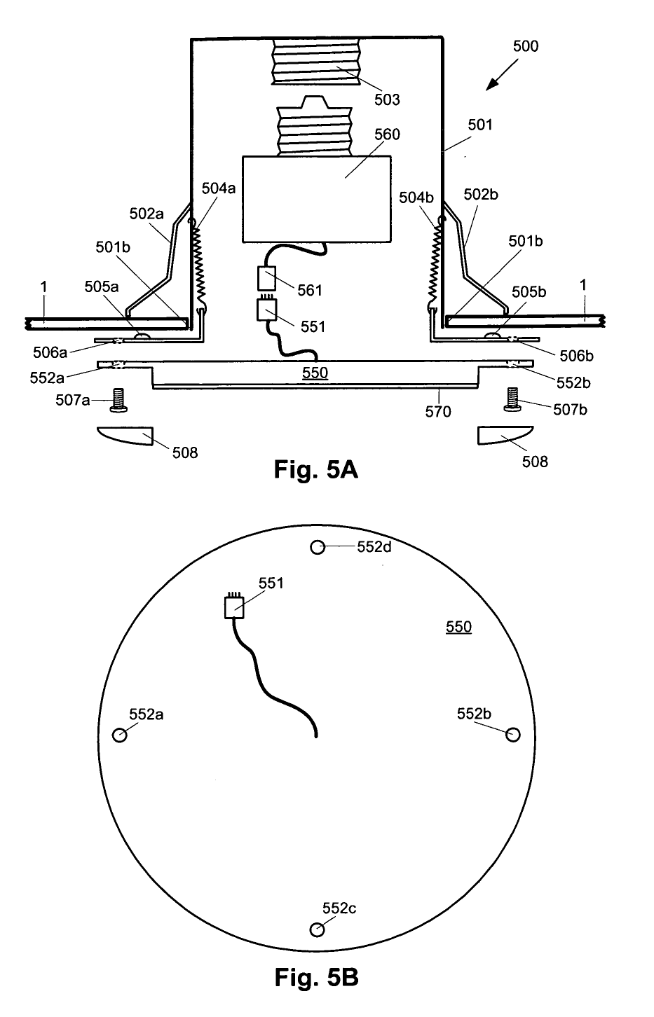

FIG. 5A shows a recessed can light fixture with a light emitting diode panel retained by bolts. FIG. 5B shows a top a view of the light emitting diode panel of FIG. 5A. As shown in FIG. 5A, the recessed can light fixture 500 includes a can 501 for containing electrical connections and a light emitting diode panel 550.

The can 501 is affixed to the ceiling 1 using the affixing tabs 502a and 502b. The affixing tabs 502a and 502b are either a part of the can 501, or fit into the can walls via a tab and slot mechanism (not shown). The can 501 is cylindrically shaped, as shown in FIG. 5A. Alternatively, the can 501 has one of a number of different shapes including that of a rectangular prism or a prism with a triangular cross section. Alternatively, the can 501 has a spherical, semi-spherical, a shape with a circular cross section or other elliptical shape. The can 501 is made from metal, plastic or a combination thereof. The can 501 has a seamless wall. Alternatively, the can 501 has a seam, holes or ancillary cavities (not shown) in the walls of the can 501.

The socket 503 supplies power to the light emitting diode panel 550 through a power supply 560. The socket 503 can alternatively receive an incandescent light bulb (not shown) or a fluorescent light bulb (not shown). The power supply 560 is electrically connected to the socket 503, as shown in FIG. 5A. The light emitting diode panel 550 is then connected to the power supply 560 by connecting the connector 551 of the light emitting diode panel 550 to the connector 561 of the power supply 560. The power supply 560 contains an AC/DC converter, a transformer and other power conversion devices (not shown). The connector 551 of the light emitting diode panel 550 and the connector 561 of the power supply 560 are reversibly connected, as shown in FIG. 5A. Alternatively, the connector 551 of the light emitting diode panel 550 and the connector 561 of the power supply 560 are permanently connected.

The connector 551 of the light emitting diode panel 550 and the connector 561 of the power supply 560 are reversibly connected using a plug and a socket type connection, as shown in FIG. 5A, or pins and sockets, tabs and slits and other types of reversible connectors (not shown). The connector 551 of the light emitting diode panel 550 is connected to the light emitting diode panel 550 via a flexible wire as shown in FIGS. 5A and 5B, or the connector 551 of the light emitting diode panel 550 is connected to the light emitting diode panel 550 via another type of interconnection, such as an inflexible wire, flexible or inflexible ribbon, flexible or inflexible post (not shown). The connector 561 of the power supply 560 is connected to the power supply 560 via a flexible wire as shown in FIGS. 5A and 5B, or in the alternative, connector 561 of the power supply 560 is connected to the power supply 560 via another type of interconnection, such as an inflexible wire, flexible or inflexible ribbon, flexible or inflexible post (not shown).

Because the connector 551 of the light emitting diode panel 550 and the connector 561 of the power supply 560 are reversibly connected, either component is independently replaceable. In particular, disconnecting the connectors 551 and 561 allows one of the light emitting diode panel 550 and the power supply 560 to be removed without having to remove the other component. This is useful since the lifetimes of the light emitting diode panel 550 and the power supply 560 differ so as to result in the need to replace one of these components more often than the other. For example, the electronics associated with the power supply 560 could be more prone to overheating and subject to short circuiting and burn-out. Reversibility of the connectors 551 and 561 allows the replacement of either the light emitting diode panel 550 or the power supply 560 as needed. Additionally, the reversibility of connectors 551 and 561 allows the quick removal and repair of either the power supply 560 or the light emitting diode panel 550.

When the light emitting diode panel 550 and power supply 560 are not installed in the can 501, a light bulb (not shown) could be inserted into the socket 503 so as to provide electrical power to the light bulb (not shown). The socket 503 is either a single bulb socket, as shown in FIG. 5A, or is a multiple socket for multiple bulbs (not shown). In another alternative, the socket 503 has other features such as an outlet (not shown) for supplying power to electronic devices (not shown) or additional connections including wires (not shown), additional sockets (not shown) or pin connects (not shown).

The recessed can light fixture 500 also includes springs 504a and 504b for retaining a plate 505 near the bottom edge 501b of the can 501, as shown in FIG. 5A. Alternatively, the plate 505 is affixed to the can 501 by fasteners (not shown) or a fastening mechanism (not shown) other than a spring. The springs 504a and 504b are fastened directly to the can, as shown in FIG. 5A. Alternatively, the springs 504a and 504b are fastened indirectly to the walls of the can through an intermediate part attached to the can 501 or through another portion of the recessed can light fixture 500.

The springs 504a and 504b allow the plate 505 to be temporarily displaced from the can in a direction away from the socket 503, when the plate is pulled in that direction by the user. Once the user ceases to pull on the plate 505, the springs 504a and 504b cause the plate 505 to return to the original configuration shown in FIG. 5A. The displacement of the plate 505 from the can 501 allowed by the springs 504a and 504b enable the removal and replacement of the light emitting diode panel 550 and the replacement of the power supply 560. Typically, the plate 505 covers the bottom edge 501b of the can 501, as shown in FIG. 5A. Alternatively, portions of the plate 505 do not cover some portions of the bottom edge 501b of the can 501 if those portions of the plate 505 do not retain the light emitting diode panel 550. The plate 505 could have one of a number of shapes, including the ring shape shown in profile in FIG. 5A.

The light emitting diode panel 550 has bolt accepting holes 552a-552d and the plate 505 has threaded bolt accepting holes 506a and 506b, as shown in FIGS. 5A and 5B, for affixing the light emitting diode panel 550. In addition, the light fixture 500 has bolts 507a and 507b and a beauty ring 508. The beauty ring 508, which has an annular shape, is shown in profile in FIG. 5A. The purpose of the beauty ring 508 covers the bolt accepting holes 552a and 552b of the light emitting diode panel 550 and bolts 507a and 507b. The beauty ring 508 is annular in shape, as shown in profile in FIG. 5A, or has one of a number of other shapes including that of a square, triangle or ellipse.

Although only two threaded bolt accepting holes 506a and 506b and two corresponding bolts 507a and 507b are shown in profile in FIG. 5A, there are four threaded bolt accepting holes and bolts in total. In the alternative, there could be two, three, five or more threaded bolt accepting holes. The number of threaded bolt accepting holes in the plate 505 and the number of bolts are at least equal to the number of bolt accepting holes in the light emitting diode panel 550. Each of the threaded bolt accepting holes 506a and 506b are positioned around the circumference of the plate 505 to a corresponding bolt, 507a and 507b, and bolt accepting hole, 552a and 552b, respectively.

Each of the bolts 507a and 507b is slid through into a corresponding bolt accepting hole, 552a and 552b, in the light emitting diode panel 550 and then screwed into a corresponding threaded bolt accepting holes 506a and 506b in the plate 505. Screwing is accomplished using a screw driver (not shown) and the bolts are one of a number of types, including standard and philips head. The action of screwing the bolts 507a and 507b into the threaded bolt accepting holes 506a and 506b affixes the light emitting diode panel 550 to the plate 505. Once the bolts 507a and 507b are screwed into the threaded bolt accepting holes 506a and 506b, the beauty ring 508 is then affixed onto the light emitting diode panel 550. The beauty ring 508 snaps onto the light emitting diode panel 550, or is affixed by one of a number of other different methods, including using screws, bolts, pins or fasteners (not shown).

The light emitting diode panel 550 is separated from the plate 505 by the following process. First, each of the bolts 507a and 507b is unscrewed from the threaded bolt accepting holes 506a and 506b. Subsequently, the bolts 507a and 507b are removed from the bolt accepting holes, 552a-552d and the beauty ring 508 is removed. Then the light emitting diode panel 550 is separated from the plate 505.

The plate 505 has bumps 505a and 505b holding the plate 505 away from the ceiling 1 to provide ventilation to the interior 501a of the can 501 so as to dissipate heat from the power supply 560 and the light emitting diode panel 550. There can be two bumps, as shown in FIG. 5A, or more than two bumps to further stabilize the plate 505 with respect to the ceiling 1. Ventilation from the air passages (not shown) created by the bumps 505a and 505b cools both the power supply 560 and light emitting diode panel 550 both of which can heat, during normal operation, to temperatures that could degrade the operating efficiency or the lifetime of the power supply 560 and light emitting diode panel 550. Cooling due to ventilation created by the bumps 505a and 505b prolongs the lifetime of the power supply 560, light emitting diode panel 550 and other electronics or connections (not shown) in the can 501.

As shown in FIG. 5A, the light emitting diode panel 550 also has a lens 570 for dispersing the light produced by the light emitting diodes (not shown) of the light emitting diode panel 550. The lens 570 distributes the light emitted by the light emitting diode panel 550 to light interior spaces more efficiently. In the alternative, the lens 570 also includes reflective surfaces to increase the refraction of redirected light, or to redirect light to specific targets. In another alternative, the lens 570 has more than one lens for both focusing and dispersion of the light created by the light emitting diode panel 550. In yet another alternative, the lens 570 further includes one or several optical elements (not shown), such as light guide panels, convex or concave lenses, filters, parabolic, flat mirrors, shaped-mirrors, polarizers or light blocking devices (not shown).

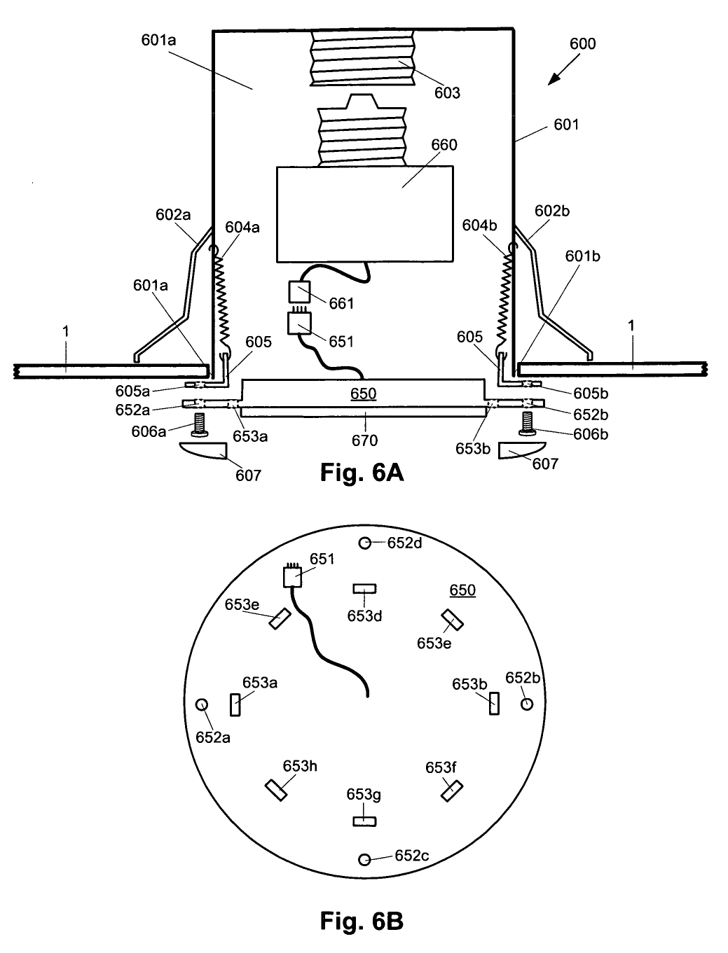

FIG. 6A shows a recessed can light fixture with a light emitting diode panel with ventilation holes retained by bolts. FIG. 6B shows a top a view of the light emitting diode panel of FIG. 6A. As shown in FIG. 6A, the recessed can light fixture 600 includes a can 601 for containing electrical connections and a light emitting diode panel 650.

The can 601 is affixed to the ceiling 1 using the affixing tabs 602a and 602b. The affixing tabs 602a and 602b are a part of the can 601, or fit into the can walls via a tab and slot mechanism (not shown). The can 601 is cylindrically shaped, as shown in FIG. 6A. Alternatively, the can 601 has one of a number of different shapes including that of a rectangular prism or a prism with a triangular cross section. Alternatively, the can 601 has a spherical, semi-spherical, a shape with a circular cross section or other elliptical shape. The can 601 is made from metal, plastic or a combination thereof. The can 601 has a seamless wall. Alternatively, the can 601 has a seam, holes or ancillary cavities (not shown) in the walls of the can 601.

The socket 603 supplies power to the light emitting diode panel 650 through a power supply 660. The socket 603 can alternatively receive an incandescent light bulb (not shown) or a fluorescent light bulb (not shown). The power supply 660 is electrically connected to the socket 603, as shown in FIG. 6A. The light emitting diode panel 650 is then connected to the power supply 660 by connecting the connector 651 of the light emitting diode panel 650 to the connector 661 of the power supply 660. The power supply 660 contains an AC/DC converter, a transformer and other power conversion devices (not shown). The connector 651 of the light emitting diode panel 650 and the connector 661 of the power supply 660 are reversibly connected, as shown in FIG. 6A. Alternatively, the connector 651 of the light emitting diode panel 650 and the connector 661 of the power supply 660 are permanently connected.

The connector 651 of the light emitting diode panel 650 and the connector 661 of the power supply 660 are reversibly connected using a plug and a socket type connection, as shown in FIG. 6A, or pins and sockets, tabs and slits and other types of reversible connectors (not shown). The connector 651 of the light emitting diode panel 650 is connected to the light emitting diode panel 650 via a flexible wire as shown in FIGS. 6A and 6B, or the connector 651 of the light emitting diode panel 650 is connected to the light emitting diode panel 650 via another type of interconnection, such as an inflexible wire, flexible or inflexible ribbon, flexible or inflexible post (not shown). The connector 661 of the power supply 660 is connected to the power supply 660 via a flexible wire as shown in FIGS. 6A and 6B, or in the alternative, connector 661 of the power supply 660 is connected to the power supply 660 via another type of interconnection, such as an inflexible wire, flexible or inflexible ribbon, flexible or inflexible post (not shown).

Because the connector 651 of the light emitting diode panel 650 and the connector 661 of the power supply 660 are reversibly connected, either component is independently replaceable. In particular, disconnecting the connectors 651 and 661 allows one of the light emitting diode panel 650 and the power supply 660 to be removed without having to remove the other component. This is useful since the lifetimes of the light emitting diode panel 650 and the power supply 660 differ so as to result in the need to replace one of these components more often than the other. For example, the electronics associated with the power supply 660 could be more prone to overheating and subject to short circuiting and burn-out. Reversibility of the connectors 651 and 661 allows the replacement of either the light emitting diode panel 650 or the power supply 660 as needed. Additionally, the reversibility of connectors 651 and 661 allows quick removal and repair of either the power supply 660 or the light emitting diode panel 650.

When the light emitting diode panel 650 and power supply 660 are not installed in the can 601, a light bulb (not shown) could be inserted into the socket 603 so as to provide electrical power to the light bulb (not shown). The socket 603 is either a single bulb socket, as shown in FIG. 6A, or is a multiple socket for multiple bulbs (not shown). In another alternative, the socket 603 has other features such as an outlet (not shown) for supplying power to electronic devices (not shown) or additional connections including wires (not shown), additional sockets (not shown) or pin connects (not shown).

The recessed can light fixture 600 also includes springs 604a and 604b for retaining a plate 605 near the bottom edge 601b of the can 601, as shown in FIG. 6A. Alternatively, the plate 605 is affixed to the can 601 by fasteners (not shown) or a fastening mechanism (not shown) other than a spring. The springs 604a and 604b are fastened directly to the can, as shown in FIG. 6A. Alternatively, the springs 604a and 604b are fastened indirectly to the walls of the can through an intermediate part attached to the can 601 or through another portion of the recessed can light fixture 600.

The springs 604a and 604b allow the plate 605 to be temporarily displaced from the can in a direction away from the socket 603, when the plate is pulled in that direction by the user. Once the user ceases to pull on the plate 605, the springs 604a and 604b cause the plate 605 to return to the original configuration shown in FIG. 6A. The displacement of the plate 605 from the can 601 allowed by the springs 604a and 604b enable the removal and replacement of the light emitting diode panel 650 and the replacement of the power supply 660. Typically, the plate 605 covers the bottom edge 601b of the can 601, as shown in FIG. 6A. Alternatively, portions of the plate 605 do not cover some portions of the bottom edge 601b of the can 601 if those portions of the plate 605 do not retain the light emitting diode panel 650. The plate 605 could have one of a number of shapes, including the ring shape shown in profile in FIG. 6A.

The light emitting diode panel 650 has bolt accepting holes 652a-652d and the plate 605 has threaded bolt accepting holes 605a and 605b, as shown in FIGS. 6A and 6B, for affixing the light emitting diode panel 650. In addition, the light fixture 600 has bolts 606a and 606b and a beauty ring 607. The beauty ring 607, which has an annular shape, is shown in profile in FIG. 6A. The purpose of the beauty ring 607 covers the bolt accepting holes 652a-652d of the light emitting diode panel 650 so that neither they nor the any bolts that they contain are visible from underneath the can 601. The beauty ring 607 is annular in shape, as shown in profile in FIG. 6A, or could have one of a number of other shapes including that of a square, triangle or ellipse.

Although only two threaded bolt accepting holes 605a and 605b and two corresponding bolts 606a and 606b are shown in profile in FIG. 6A, there are four threaded bolt accepting holes and bolts in total. In the alternative, there could be two, three, five or more threaded bolt accepting holes, bolts and bolt accepting holes. The number of threaded bolt accepting holes in the plate 605 and the number of bolts are at least equal to the number of bolt accepting holes in the light emitting diode panel 260. Each of threaded bolt accepting holes 605a and 605b is positioned around the circumference of the plate 605 to correspond to a bolt 606a and 606b, and bolt accepting hole 652a and 652b, respectively.

Each of the bolts 606a and 606b is slid through into a corresponding bolt accepting hole 652a and 652b in the light emitting diode panel 650, and then screwed into a corresponding threaded bolt accepting holes 605a and 605b in the plate 605. Screwing is accomplished using a screw driver (not shown) and the bolts is of one of a number of types, including standard and philips head. The action of screwing the bolts 606a and 606b into the threaded bolt accepting holes 605a and 605b affixes the light emitting diode panel 650 to the plate 605. Once the bolts 606a and 606b are screwed into the threaded bolt accepting holes 605a and 605b, the beauty ring 607 is affixed onto the light emitting diode panel 650. The beauty ring 607 can snap onto the light emitting diode panel 650, or is affixed by one of a number of other different methods including using screws, bolts, pins or fasteners (not shown).

The light emitting diode panel 650 is separated from the plate 605 by the following process. First, each of the bolts 606a and 606b is unscrewed from the threaded bolt accepting holes 605a and 605b. Subsequently, the bolts 606a and 606b are removed from the bolt accepting holes, 651a-651d and the beauty ring 607 is removed. Then the light emitting diode panel 650 is separated from the plate 605.

The light emitting diode panel 650 has ventilation holes 653a-653h to provide ventilation to the interior 601a of the can 601 so as to dissipate heat from the power supply 660 and the light emitting diode panel 650 emits heat during operation. There are eight ventilation holes, as shown in FIG. 6B, or there are either more or fewer than eight ventilation holes. Air flow through the ventilation holes 653a-653h cools both the power supply 660 and light emitting diode panel 650 both of which can heat, during normal operation, to temperatures that could degrade the operating efficiency or the lifetime of the power supply 660 and light emitting diode panel 650. Cooling from the air flow through the ventilation holes 653a-653h prolongs the lifetime of the power supply 660, light emitting diode panel 650 and other electronics or connections (not shown) in the can 601.

As shown in FIG. 6A, the light emitting diode panel 650 also has a lens 670 for dispersing the light produced by the light emitting diodes (not shown) of the light emitting diode panel 650. The lens 670 distributes the light emitted by the light emitting diode panel 650 to light interior spaces more efficiently. In the alternative, the lens 670 also includes reflective surfaces to increase the refraction of redirected light, or to redirect light to specific targets. In another alternative, the lens 670 has more than one lens for both focusing and dispersion of the light created by the light emitting diode panel 650. In yet another alternative, the lens 670 further includes one or several optical elements (not shown), such as light guide panels, convex or concave lenses, filters, parabolic, flat mirrors, shaped-mirrors, polarizers or light blocking devices (not shown).

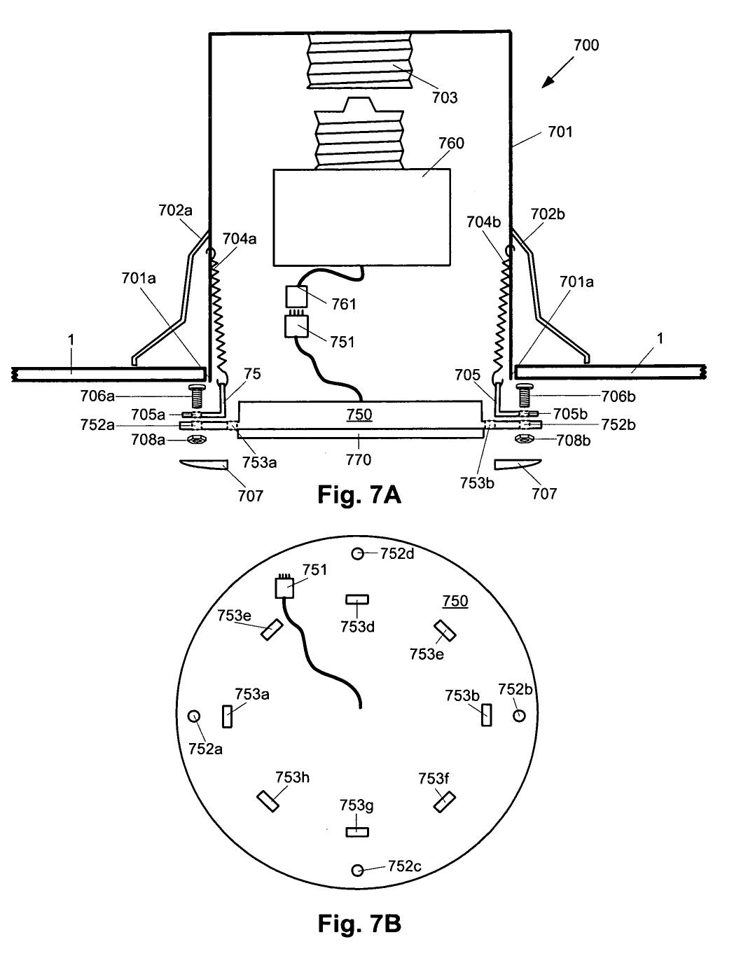

FIG. 7A shows a recessed can light fixture with a light emitting diode panel with ventilation holes retained by bolts. FIG. 7B shows a top a view of the light emitting diode panel of FIG. 7A. As shown in FIG. 7A, the recessed can light fixture 700 includes a can 701 for containing electrical connections and a light emitting diode panel 750.

The can 701 is affixed to the ceiling 1 using the affixing tabs 702a and 702b. The affixing tabs 702a and 702b are a part of the can 701, or fit into the can walls via a tab and slot mechanism (not shown). The can 701 is cylindrically shaped, as shown in FIG. 7A. Alternatively, the can 701 has one of a number of different shapes including that of a rectangular prism or a prism with a triangular cross section. Alternatively, the can 701 has a spherical, semi-spherical, a shape with a circular cross section or other elliptical shape. The can 701 is made from metal, plastic or a combination thereof. The can 701 has a seamless wall. Alternatively, the can 701 has a seam, holes or ancillary cavities (not shown) in the walls of the can 701.

The socket 703 supplies power to the light emitting diode panel 750 through a power supply 760. The socket 703 can alternatively receive an incandescent light bulb (not shown) or a fluorescent light bulb (not shown). The power supply 760 is electrically connected to the socket 703, as shown in FIG. 7A. The light emitting diode panel 750 is then connected to the power supply 760 by connecting the connector 751 of the light emitting diode panel 750 to the connector 761 of the power supply 760. The power supply 760 contains an AC/DC converter, a transformer and other power conversion devices (not shown). The connector 751 of the light emitting diode panel 750 and the connector 761 of the power supply 760 are reversibly connected, as shown in FIG. 7A. Alternatively, the connector 751 of the light emitting diode panel 750 and the connector 761 of the power supply 760 are permanently connected.

The connector 751 of the light emitting diode panel 750 and the connector 761 of the power supply 760 are reversibly connected using a plug and a socket type connection, as shown in FIG. 7A, or pins and sockets, tabs and slits and other types of reversible connectors (not shown). The connector 751 of the light emitting diode panel 750 is connected to the light emitting diode panel 750 via a flexible wire as shown in FIGS. 7A and 7B, or the connector 751 of the light emitting diode panel 750 is connected to the light emitting diode panel 750 via another type of interconnection, such as an inflexible wire, flexible or inflexible ribbon, flexible or inflexible post (not shown). The connector 761 of the power supply 760 is connected to the power supply 760 via a flexible wire as shown in FIGS. 7A and 7B, or in the alternative, connector 761 of the power supply 760 is connected to the power supply 760 via another type of interconnection, such as an inflexible wire, flexible or inflexible ribbon, flexible or inflexible post (not shown).

Because the connector 751 of the light emitting diode panel 750 and the connector 761 of the power supply 760 are reversibly connected, either component is independently replaceable. In particular, disconnecting the connectors 751 and 761 allows one of the light emitting diode panel 750 and the power supply 760 to be removed without having to remove the other component. This is useful since the lifetimes of the light emitting diode panel 750 and the power supply 760 differ so as to result in the need to replace one of these components more often than the other. For example, the electronics associated with the power supply 760 could be more prone to overheating and subject to short circuiting and burn-out. Reversibility of the connectors 751 and 761 allows the replacement of either the light emitting diode panel 750 or the power supply 760 as needed. Additionally, the reversibility of connectors 751 and 761 allows quick removal and repair of either the power supply 760 or the light emitting diode panel 750.

When the light emitting diode panel 750 and power supply 760 are not installed in the can 701, a light bulb (not shown) could be inserted into the socket 703 so as to provide electrical power to the light bulb (not shown). The socket 703 is either a single bulb socket, as shown in FIG. 7A, could have spaces for multiple bulbs (not shown). In another alternative, the socket 703 has other features, such as an outlet (not shown) for supplying power to electronic devices (not shown), or additional connections, including wires (not shown), additional sockets (not shown) or pin connects (not shown).

The recessed can light fixture 700 also includes springs 704a and 704b for retaining a plate 705 near the bottom edge 701b of the can 701, as shown in FIG. 7A. Alternatively, the plate 705 is affixed to the can 701 by fasteners (not shown) or a fastening mechanism (not shown) other than a spring. The springs 704a and 704b are fastened directly to the can, as shown in FIG. 7A. Alternatively, the springs 704a and 704b are fastened indirectly to the walls of the can through an intermediate part attached to the can 701 or through another portion of the recessed can light fixture 700.

The springs 704a and 704b allow the plate 705 to be temporarily displaced from the can in a direction away from the socket 703, when the plate is pulled in that direction by the user. Once the user ceases to pull on the plate 705, the springs 704a and 704b cause the plate 705 to return to the original configuration shown in FIG. 7A. The displacement of the plate 705 from the can 701 allowed by the springs 704a and 704b enable the removal and replacement of the light emitting diode panel 750 and the replacement of the power supply 760. Typically, the plate 705 covers the bottom edge 701b of the can 701, as shown in FIG. 7A. Alternatively, portions of the plate 705 do not cover some portions of the bottom edge 701b of the can 701 if those portions of the plate 705 do not retain the light emitting diode panel 750. The plate 705 could have one of a number of shapes, including the ring shape shown in profile in FIG. 7A.

The light emitting diode panel 750 has bolt accepting holes 752a-752d and the plate 705 has bolt accepting holes 705a and 705b, as shown in FIGS. 7A and 7B, for affixing the light emitting diode panel 750. In addition, the light fixture 700 has bolts 706a and 706b, nuts 708a and 708b as well as a beauty ring 707. The beauty ring 707, which has an annular shape, is shown in profile in FIG. 7A. The purpose of the beauty ring 707 covers the bolt accepting holes 752a-752d of the light emitting diode panel 750 so that neither the bolt accepting holes 752a-752d nor the nuts contained within them are visible from underneath the can 701. The beauty ring 707 is annular in shape, as shown in profile in FIG. 7A, could have one of a number of other shapes including that of a square, triangle or ellipse.

Although only two bolt accepting holes 705a and 705b, two corresponding bolts 706a and 706b and two corresponding nuts 708a and 708b are shown in profile in FIG. 7A, there are four bolt accepting holes, bolts and nuts in total on the plate 705. In the alternative, there could be two, three, or five bolt accepting holes in the plate 705, bolts, bolt accepting holes in the light emitting diode panel 750. The number of bolt accepting holes in the plate 705, the number of bolts and the number of nuts are at least equal to the number of bolt accepting holes in the light emitting diode panel 750. Each of the bolt accepting holes 705a and 705b is positioned around the circumference of the plate 705 to correspond to a bolt 706a and 706b, nut 708a and 708b, and bolt accepting hole 752a-752d, respectively.

Each of the bolts 706a and 706b is slid first through a corresponding bolt accepting hole 705a and 705b in the plate 705, then is slid through a corresponding bolt accepting hole 752a and 752b in the light emitting diode panel 750. Subsequently, each of the bolts 706a and 706b is screwed into a corresponding nut 708a and 708d. Screwing the bolts 706a and 706b into the nuts 708a and 708b is accomplished using a screw driver (not shown). Each of the bolts 706a and 706b is of one of a number of types, including standard and philips head. The action of screwing the bolts 706a and 706b into the nuts 708a and 708b affixes the light emitting diode panel 750 to the plate 705. Once the bolts 706a and 706b are screwed into the into the nuts 708a and 708b, the beauty ring 707 is then affixed onto the light emitting diode panel 750. The beauty ring 707 can snap onto the light emitting diode panel 750, or is affixed by one of a number of other different methods including using screws, bolts, pins or fasteners (not shown).

The light emitting diode panel 750 is separated from the plate 705 by the following process. First, each of the bolts 706a and 706b is unscrewed from one of the nuts 708a and 708b. Subsequently, the bolts 706a and 706b are removed from the bolt accepting holes 752a-752d and the beauty ring 707 is removed. Then the light emitting diode panel 750 is separated from the plate 705.

The light emitting diode panel 750 has ventilation holes 753a-753h to provide ventilation to the interior 701a of the can 701 so as to dissipate heat from the power supply 760 and the light emitting diode panel 750 emits heat during operation. There are eight ventilation holes, as shown in FIG. 7B, or there are either more or fewer than eight ventilation holes. Air flow through the ventilation holes 753a-753h cools both the power supply 760 and light emitting diode panel 750 both of which can heat, during normal operation, to temperatures that could degrade the operating efficiency or the lifetime of the power supply 760 and light emitting diode panel 750. Cooling from the air flow through the ventilation holes 753a-753h prolongs the lifetime of the power supply 760, light emitting diode panel 750 and other electronics or connections (not shown) in the can 701.

As shown in FIG. 7A, the light emitting diode panel 750 also has a lens 770 for dispersing the light produced by the light emitting diodes (not shown) of the light emitting diode panel 750. The lens 770 distributes the light emitted by the light emitting diode panel 750 to light interior spaces more efficiently. In the alternative, the lens 770 also includes reflective surfaces to increase the refraction of redirected light, or to redirect light to specific targets. In another alternative, the lens 770 has more than one lens for both focusing and dispersion of the light created by the light emitting diode panel 750. In yet another alternative, the lens 770 further includes one or several optical elements (not shown), such as light guide panels, convex or concave lenses, filters, parabolic, flat mirrors, shaped-mirrors, polarizers or light blocking devices (not shown).

It will be apparent to those skilled in the art that various modifications and variations is made in the recessed can light fixture of embodiments of the invention without departing from the spirit or scope of the invention. Thus, it is intended that embodiments of the invention cover the modifications and variations of this invention provided they come within the scope of the appended claims and their equivalents.

What is claimed is:

1. A lighting device for an opening of a recessed light fixture comprising:
a plate for mounting at the opening of the recessed light fixture, the plate having a first side for facing the recessed light fixture and a second side opposite to the first side;
a light emitting diode lighting panel attached at the second side of the plate; and
a power supply unit for insertion into a socket of the recessed light fixture, wherein the power supply unit is for providing power to the light emitting diode panel.

2. The lighting device of claim 1, further comprising a spring for attaching the plate to the recessed light fixture.

3. The lighting device of claim 1, wherein the lighting device further includes:
posts on the second side of the plate; and
eyelets on the light emitting diode lighting panel for receiving the posts.

4. The lighting device of claim 1, wherein the light emitting diode lighting panel is mounted onto the plate by pins.

5. The lighting device of claim 1, wherein the light emitting diode lighting panel is mounted onto the plate by dips.

6. The lighting device of claim 1, wherein the plate has bumps on the first side of the plate for ventilation.

7. The lighting device of claim 1, wherein the light emitting diode lighting panel has openings for ventilation.

8. The lighting device of claim 1, wherein the light emitting diode lighting panel includes a flexible strip of light emitting diodes.

9. A lighting device for an opening of a recessed light fixture comprising:
a plate for mounting at the opening of the recessed light fixture, the plate having a first side for facing the recessed light fixture and a second side opposite to the first side;
a light emitting diode lighting panel attached at the second side of the plate, the light emitting diode lighting panel having a first connector; and
a power supply unit for insertion into a socket of the recessed light fixture, wherein the power supply unit has a second connector for connecting to the first connector.

10. The lighting device of claim 9, further comprising a spring for attaching the plate to the recessed light fixture.

11. The lighting device of claim 9, wherein the lighting device further includes:
posts on the second side of the plate; and
eyelets on the light emitting diode lighting panel for receiving the posts.

12. The lighting device of claim 9, wherein the light emitting diode lighting panel is mounted onto the plate by pins.

13. The lighting device of claim 9, wherein the light emitting diode lighting panel is mounted onto the plate by clips.

14. The lighting device of claim 9, wherein the plate has bumps on the first side of the plate for ventilation.

15. The lighting device of claim 9, wherein the light emitting diode lighting panel has openings for ventilation.

16. The lighting device of claim 9, wherein the light emitting diode lighting panel includes a flexible strip of light emitting diodes.

17. A lighting device for an opening of a recessed light fixture comprising:
a plate for mounting at the opening of the recessed light fixture, the plate having a first side for facing the recessed light fixture and a second side opposite to the first side;
a light emitting diode lighting panel attached at the second side of the plate, the light emitting diode lighting panel including a flexible strip of light emitting diodes;
attachment mechanisms for affixing the light emitting diode lighting panel at the second side of the plate; and
a power supply unit for insertion into a socket of the recessed light fixture, wherein the power supply unit has a second connector for connecting to the first connector.

18. The lighting device of claim 17, wherein the plate has bumps on the first side of the plate for ventilation.

19. The lighting device of claim 17, wherein the light emitting diode lighting panel has openings for ventilation.

20. The lighting device of claim 17, further comprising a beauty ring for covering the attachment mechanisms.
